(19) United States
(12) Patent Application Publication
(10) Pub. No.: US 2020/0081150 A1
(43) Pub. Date: Mar. 12, 2020

(54) PULSED NEUTRON AZIMUTHAL MEASUREMENT SYSTEM AND METHOD

(71) Applicant: Baker Hughes, a GE Company, LLC, Houston, TX (US)

(72) Inventor: Feyzi Inanc, Houston, TX (US)

(73) Assignee: Baker Hughes, a GE Company, LLC, Houston, TX (US)

(21) Appl. No.: 16/125,047

(22) Filed: Sep. 7, 2018

(51) Int. Cl. G01V 5/10; G01T 3/02

(52) U.S. Cl. CPC G01V 5/108; G01T 3/02

(57) ABSTRACT

Embodiments of the present disclosure include a downhole inspection system including a neutron generation unit operable to emit neutrons toward a target in a wellbore. The system also includes a neutron detection unit fixed relative to the neutron generator and operable to detect thermal neutrons from the target. The system includes a shielding arrangement forming at least a portion of the neutron detection unit, the shielding arrangement blocking at least a portion of the thermal neutrons, from penetrating beyond a predetermined radial location within the neutron detection unit.

### BACKGROUND

### 1. Field of Invention

This disclosure relates in general to oil and gas tools, and in particular, to systems and methods for downhole imaging operations.

### 2. Description of the Prior Art

Hydrocarbon producing wellbores typically require verification of the integrity of the wellbore structure for commissioning, during extended operation, and for decommissioning purposes. Particularly for decommissioning of offshore wells, it is of high interest to verify the integrity of the wellbore-to-formation boundary to ensure that the offshore well can be effectively plugged and abandoned. Thus, the integrity of wellbore-to-formation boundary needs to be verified before a plug and abandon operation can begin. For example, this may include verifying that there are no significant channel defects in the cement structure of the wellbore. Typically, as a first inspection step, the production casing is removed before the integrity of a wellbore can be measured using conventional inspection tools. The casing removal process, which may include the removal of 10,000 feet of casing, is time consuming and costly. Furthermore, integrity inspection of multi-barrier wellbores, with multiple casing and cement annuli, is a challenging task.

### SUMMARY

Applicant recognized the problems noted above herein and conceived and developed embodiments of systems and methods, according to the present disclosure, for imaging operations.

In an embodiment, a downhole inspection system includes a downhole tool string lowerable into a wellbore and a neutron imaging device forming at least a portion of the downhole tool string. The neutron imaging device is operable to generate neutron imaging data for detecting a wellbore characteristic and includes a neutron generator operable to emit neutrons toward a target. The neutron imaging device also includes a plurality of neutron detectors fixed relative to the neutron generator and operable to detect backscattered neutrons from the target. The neutron imaging device includes a shielding arrangement to absorb thermal neutrons positioned between adjacent neutron detectors of the plurality of neutron detectors, the shielding arrangement positioned to establish azimuthal sensitivity for the respective detectors.

In another embodiment, a downhole inspection system includes a neutron generation unit operable to emit neutrons toward a target in a wellbore. The system also includes a neutron detection unit fixed relative to the neutron generator and operable to detect neutrons from the target. The system includes a shielding arrangement forming at least a portion of the neutron detection unit, the shielding arrangement blocking at least a portion of the thermal neutrons from penetrating beyond a predetermined radial location within the neutron detection unit.

In an embodiment, a method of inspecting a wellbore includes positioning a neutron imaging device in a wellbore having a casing. The method also includes emitting neutrons toward a portion of the wellbore. The method further includes detecting thermal neutrons from the portion of the wellbore. The method also includes generating neutron imaging data for the portion of the wellbore based at least in part on the detected thermal neutrons. The method further includes correlating the neutron imaging data to an azimuthal position of the wellbore.

### BRIEF DESCRIPTION OF THE DRAWINGS

The present technology will be better understood on reading the following detailed description of non-limiting embodiments thereof, and on examining the accompanying drawings, in which:

FIG. 1 is a schematic cross-sectional view of an embodiment of an inspection probe within a wellbore, in accordance with embodiment of the present disclosure;

FIG. 2 is a schematic radial cross-sectional view of an embodiment of an inspection probe within a wellbore, in accordance with embodiments of the present disclosure;

FIG. 3A is a schematic perspective view of an embodiment of an inspection probe, in accordance with embodiments of the present disclosure;

FIG. 3B is a graphical representation of a time spectrum from a pulsed neutron generator, in accordance with embodiments of the present disclosure;

FIG. 4 is a schematic perspective view of an embodiment of a shielding arrangement for a neutron detector, in accordance with embodiment of the present disclosure;

FIG. 5 is a schematic top plan view of an embodiment of a shielding arrangement for a neutron detector, in accordance with embodiments of the present disclosure;

FIG. 6A is a graphical representation of an energy spectra, in accordance with embodiments of the present disclosure;

FIG. 6B is a graphical representation of an energy spectra, in accordance with embodiments of the present disclosure;

FIG. 7 is a flow chart of an embodiment of a method of forming a shielded neutron detector, in accordance with embodiments of the present disclosure; and

FIG. 8 is a flow chart of an embodiment of a method of determining an azimuthal position of a wellbore defect, in accordance with embodiments of the present disclosure.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

Wellbore measurements and imaging with azimuthal variation forms are desirable for obtaining information within a wellbore. For example, logging while drilling (LWD) gamma ray measurements may provide both bulk and azimuthally binned gamma ray measurements. The tool body may provide the shielding necessary for the azimuthal measurement. However, such tool body shielding is not available for wireline tools. Furthermore, gamma-gamma density measurements are inherently directional measurements. The gamma source on the tools is usually collimated to send the gamma rays into a certain volume of the formation and the detectors are collimated to look into that volume illuminated by the collimated source. When it comes to collimation, the gamma rays have an advantage over the high energy neutrons because gamma ray attenuation is a function of the target atomic number and density. Therefore, using collimators based on high density and high atomic numbers, such as tungsten, can collimate the gamma ray beams.

Such shielding and measurement properties are not available for neutrons. Neutron attenuation is not determined by the atomic number and density of the target material. As a result, neutrons can go through significant amounts of material, such as iron, especially if they are high energy neutrons. Stopping and absorbing neutrons usually is performed by 1) slowing the neutrons down, and 2) subjecting the neutrons to a high absorption cross section material. Chlorine, boron, gadolinium are among the high absorption cross section materials. Due to the challenges associated with collimation and detection of neutrons, there are no azimuthal measurements from high energy neutron sources, especially if the detection is based on the neutrons.

Embodiments of the present disclosure include a shielding arrangement that may be utilized with a neutron imaging tool. In various embodiments, the neutron imaging tool may include a neutron generation unit, which may be a pulsed neutron generator, and a neutron detection unit. The neutron detection unit, in various embodiments, including a plurality of neutron detectors, each separated by at least a portion of the shielding arrangement to form individual detection sections. The detection sections may be correlated to an azimuthal position of the wellbore, which may be incorporated with imaging data to detect various wellbore characteristics, such as defects in wellbore components. In various embodiments, the shielding arrangement includes high absorption cross section material to block thermal neutrons from passing between adjacent detection sections. In certain embodiments, the thermal neutrons may be detected during a thermal gate associated with the pulsed neutron generator. That is, the thermal neutrons may be detected after initial fast neutrons emitted during the burst gate have lost energy, thereby providing an environment that is predominantly thermal neutrons. As a result, detected backscatter radiation within a particular detection section may be reasonably correlated to a facing azimuthal portion of the wellbore because thermal neutrons may be blocked from interacting with different radiation detectors. In various embodiments, the shielding arrangement is arranged circumferentially about the neutron detection unit and also converges inwardly toward an axis of the neutron detection unit. Different numbers of detection sections may be arranged about the neutron detection unit, thereby providing more or less granular azimuthal sections for evaluation.

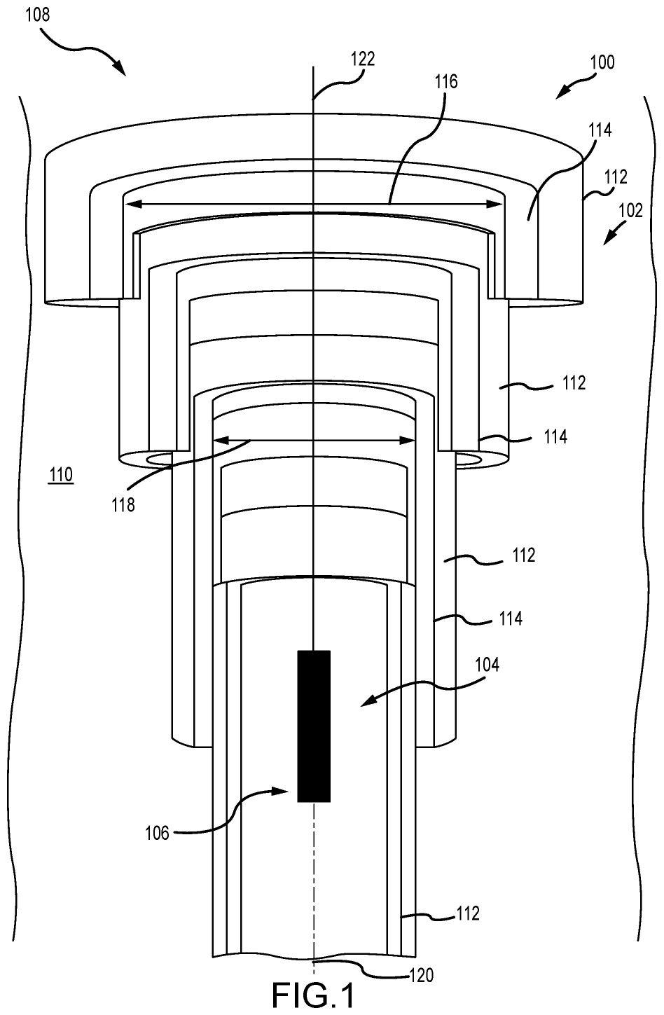

FIG. 1 is a partial cross-sectional view of a well integrity inspection system 100 illustrating a multi-barrier well structure 102 and an inspection probe 104 arranged as at least a portion of a downhole tool string 106. It should be appreciated that, as used herein, tool string 106 may refer to one or more downhole tools coupled to a conveyance system that enables logging, perforating, drilling, wellbore intervention, or the like. In various embodiments, the inspection probe 104 may be utilized to detect abnormalities or potential defects within a wellbore 108. In the illustrated embodiment, the inspection probe 104 may include a neutron imaging device configured to interrogate a formation 110 and/or the multi-barrier well structure 102 with neutron energy (e.g., fast neutrons having energy of approximately 14.1 MeV upon emission from a neutron generator, which may be a pulsed neutron generator) and later detect backscattered neutrons to determine information about the structure 102.

In the illustrated embodiment, the well structure 102 includes a series of tubular casings 112, which may be metallic, and cement walls 114 between the casings 112. Often, when drilling hydrocarbon wells, a first wellbore diameter 116 is larger than a second wellbore diameter 118. In other words, as the wellbore 108 gets deeper, the diameter decreases. In various embodiments, the wellbore 108 may be cased, as in, lined by the tubular casings 112 and held into place against the formation 110 and/or other casing sections via cement forming the cement walls 114. It may be desirable to inspect the integrity of the casing 112 and/or the cement walls 114, for example for potential abnormalities or defects such as mud channel defects, bonding defects, air voids, defects in the casing, eccentricity of the well. In various embodiments, the defects may be categorized such as such as annulus defects, casing defects, casing eccentricity, cement bonding defects, and fluid channel defects, among others. These abnormalities or defect may be referred to as wellbore characteristics and may further include additional information such as formation properties and the like.

In the illustrated embodiment, the inspection probe 104 traverses into the wellbore 108 along a wellbore axis 120 supported by a wireline 122, which may be a cable reinforced for wellbore operations and further including conductive materials to transfer energy and data signals. It should be appreciated that while a wireline system is illustrated in FIG. 1, embodiments of the present disclosure may be disposed on rigid tubing, coiled tubing, and with various other wellbore tubing structures. In various embodiments, the inspection probe 104 can determine the integrity of each of the barriers (e.g., casings) of the multi-barrier well and/or the plurality of annuli between the barriers. The inspection probe 104 is deployed at the different depths inside the wellbore 108, and therefore has material and structural integrity to withstand the high pressures and high temperatures at these depths.

It should be appreciated that various embodiments discussed herein describe the inspection probe 104 is a neutron imaging tool, which may include a neutron generation unit and a neutron detection unit. The neutron generation unit may emit a flux of neutron radiation into the formation 110, which may interact with one or more targets and produce a backscatter stream of neutrons toward the neutron detection unit. In various embodiments, the neutron generation unit is a pulsed neutron generator that emits neutrons for a period of time and then stops emitting neutrons. For example, the pulsed neutron generator may be a D-T generator that emits neutrons for approximately 60 microseconds and then stops emitting neutrons for a period of time. As a result, in various embodiments where the neutron generation unit is a pulsed neutron generator, the formation may be initially flooded with high energy fast neutrons, which may be referred to as the burst gate, and then contain predominantly (or entirely in certain embodiments) thermal neutrons during what may be referred to as a thermal gate or capture gate. The neutron detection unit may include a plurality of neutron detectors that, through neutron absorption, detect the presence of neutrons, such as thermal neutrons. The detection of the neutrons may be referred to as neutron imaging data and may be utilized to detect the wellbore characteristics. Moreover, the inspection probe 104 may include numerous interrogation modalities, each having an excitation assembly for generating the respective beam or signal to make various wellbore measurements. The wellbore measurement information from each imaging modality may be analyzed and fused with data from other imaging modalities. The inspection probe 104 may include all or a subset of the following imaging modalities. For example, the inspection probe 104 may include a neutron modality to detect annular defects, such as by measuring differences in hydrogen content, which may be indicative of an oil based mud (OBM) channel defect or a good cement annulus. The inspection probe 104 may include an X-ray modality for detecting bonding defects. The inspection probe 104 may include a gamma modality to measure differences in material densities, such as for detecting an air void or a defect free steel casing. The inspection probe 104 may include an electromagnetic modality such as pulsed eddy current (PEC) to measure casing eccentricities and casing material defects. A casing eccentricity is a defect where the individual casings are not concentric. The electromagnetic modality may be blind to non-conductive materials and therefore is not influenced by density variations in cement or defects in non-conductive parts of the wellbore. The inspection probe 14 may include an ultrasound probe to measure quality of the casing to cement annulus bond interface and thus may be used for the detection of microannuli. A microannulus is a small gap between metal casing and cement annulus. The inspection probe 104 may also include an acoustic modality to measure fluid flow behind casings, such as fluid flow between zonal isolated sections, which may indicate a structural flaw. These modalities can provide various types information about the structural integrity of a wellbore, such as annulus defects, casing defects, casing eccentricity, cement bonding defects, fluid channel defects, among others. Data from all or a subset of these modalities may be analyzed and data fused in various combinations to gain additional insight and remove confounding factors.

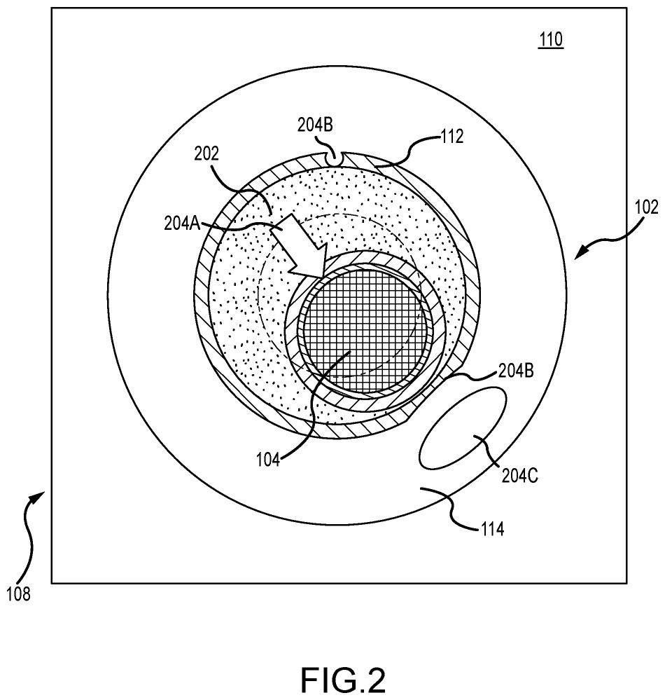

FIG. 2 is a schematic radial cross-sectional view of a wellbore environment 200 including the well structure 102. In various embodiments, a neutron modality may be used to identify possible wellbore defects based on hydrogen differences and the like. Moreover, detecting backscatter radiation from the casing 112, cement 114, formation 110, and the like may be indicative of an area of the wellbore 108 having the defect or abnormality. For example, in the illustrated embodiment, the inspection probe 104 is positioned within a wellbore annulus 202 formed within the interior of the casing 112. The annulus may contain a fluid, such as brine, water, production fluids, or the like. The cement wall 114 connects the casing 112 to the formation 110, thereby forming the cased wellbore 108. In the illustrated embodiment, wellbore characteristics 204 are arranged at various portions of the wellbore 108, such as the eccentricity defect 204A, casing defect 204B, and cement defect 204C. In various embodiments, it may be desirable to not only detect the presence of the wellbore characteristic 204, but also the azimuthal position of the defect relative to a position of the inspection probe 104. As will be described herein, various embodiments of the present disclosure include one or more shielding configurations to enable improved detection of wellbore characteristics via one or more imaging techniques.

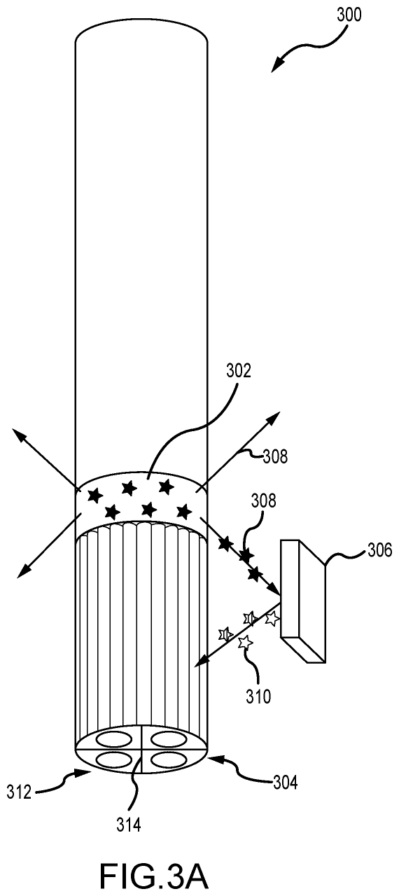

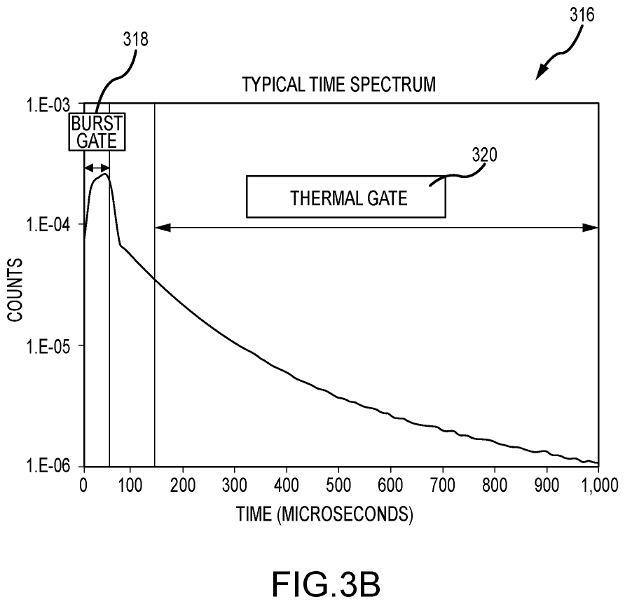

FIG. 3A is a schematic perspective view of an embodiment of a neutron imaging device 300, which may be the inspection probe 104. The illustrated neutron imaging tool 300 includes a neutron generation unit 302 and a neutron detection unit 304. As discussed above, in various embodiments, the neutron generation unit 302 is a pulsed neutron generator that emits neutrons for a period of time and then stops emitting neutrons for a second period of time. In the illustrated embodiment, the neutron detection unit 304 is fixed relative to the neutron generation unit 302. That is, movement of the neutron generation unit 302 will also be associated with equal movement of the neutron detection unit 304. In various embodiments, the generation unit 302 includes one or more neutron generators to produce neutrons at an energy of approximately 14.1 MeV, which may be termed a “fast” neutron. In embodiments, the neutron generator unit 302 is a pulsed generator that emits a neutron flux for a period of time, ceases to emit the neutron flux for a period of time, and then emits the neutron flux for a period of time. For example, the high-energy radiation (e.g., DD or DT neutrons) may be emitted from the generation unit 302 toward a target 306, such as a portion of the casing 112, portion of the cement wall 114, portion of the formation 110, or any other reasonable downhole feature. The radiation may be emitted for periods of time to enable accumulation of certain types of radiation. For example, as fast neutrons interact with other particles, energy is lost and the neutrons may become thermal neutrons (e.g., neutrons with energy less than 0.8 eV), which may be captured and detected within the detection unit 304. Initially, a majority of the neutrons will be fast neutrons, but over time, the fast neutrons will lose energy, for example due to interactions, and become thermal neutrons. The initial load of fast neutrons may be referred to as a burst gate while the later periods with predominantly thermal neutrons may be referred to as a thermal gate or capture gate.

In the illustrated embodiment, a neutron flux 308 may be transmitted radially outward from the generation unit 302. It should be appreciated that, initially, the neutron flux 308 may be mostly high energy, fast neutrons that will interact and thermalize over time. In various embodiments, the neutron flux 308 is a circumferential flux moving radially outward from the generation unit 302. However, in various embodiments, the neutron flux 308 may be directed or otherwise targeted toward a particular location. The neutrons forming the neutron flux 38 interact with the target 308 and backscatter 310 is generated. For example, the neutrons may interact with a particle and be reflected or otherwise change direction back toward the detection unit 304, where the neutrons may be captured and detected. In various embodiments, the backscatter 310 is formed from thermal neutrons, which may be detected by various detectors and/or absorbed by a high absorption cross section shielding material, as will be described below.

In various embodiments, the detection unit 304 includes one or more neutron detectors 312, such as a He-3 gas detector, Li-6 glass detector, boron trifluoride (BF3) detector, or any other reasonable neutron detector. It should be appreciated that various neutron detectors are capable of detecting thermal neutrons more efficiently while they can detect higher energy neutrons as well, but with lower efficiency. The detectors arranged closest to the backscatter 310 may not detect a portion of the neutrons forming the backscatter 310, but rather, other detectors 312 arranged within the detection unit 304 may record the neutrons that traversed through the detectors closest to the backscatter 310 undetected. Accordingly, imaging results obtained may be inaccurate and, as a result, defects may be difficult to locate. Embodiments of the present disclosure utilize the illustrated shielding arrangement 314 to reduce the likelihood that thermal neutrons will be detected by detectors 312 that are not azimuthally aligned with the target 306. In other words, in various embodiments, the shielding arrangement 314 may be utilized to provide azimuthal measurements using pulsed based thermal neutrons.

In various embodiments, the detectors 314 utilized in the neutron imaging device 300 are a cluster of detectors, each separated from the other detectors 314 with a separator or shielding arrangement 314. The separator may contain significant amounts of high thermal neutron absorbing material. A non-limiting list of high thermal neutron absorbing materials includes boron, gadolinium, and others. During operation, neutrons may be emitted from a neutron generation unit 302 in an isotropic manner. Over time (e.g., 8-50 microseconds) neutrons may be reduced from an initial fast energy level (e.g., 14.1 MeV) to approximately thermal energy levels (e.g., less than 0.8 eV). These thermal neutrons may then be detected and utilized to identify wellbore characteristics.

FIG. 3B is a graphical representation of an embodiment of a time spectrum 316 associated with the neutron generation unit 302, where the neutron generation unit 302 is a pulsed neutron generator. As described above, a pulsed neutron generator emits neutrons for a while and it stops emitting neutrons. For example, with a D-T generator energy of the neutrons is around 14.1 MeV. In the example shown in FIG. 3B, the neutrons are emitted for 60 micro seconds. A typical neutron thermalization time is shorter than 60 microseconds, for example it may be as short as 7 to 8 microseconds in hydrogen rich environment. Therefore, there will be not only fast neutrons in that time interval but thermal neutrons as well. In other words, during the period of time the neutron generator 302 is emitting neutrons, there may be a mixture of both fast and thermal neutrons within the formation. Moreover, there may also be some thermal neutrons left over from the previous pulsing period. In various embodiments, data acquired in this time period can be called burst gate data, represented by the period identified with 318. Once the neutron emission stops, all high energy neutrons will eventually thermalize and the medium will have only thermal neutrons in the system till the generator starts emitting neutrons again. Any data acquired in that time interval can be called thermal gate data, represented by the period identified with 320.

FIG. 3B illustrates the spectra 316 where the number of counts is higher in the burst gate 318 than the thermal gate 320. However, approximately 60 percent to 80 percent of the data acquired in the burst gate 318 may be due to fast neutrons, rather than the desirable thermal neutrons that may be detected by the various detectors 312 described above. Accordingly, it may be advantageous to wait to perform data acquisition until the thermal gate 320. As will be described below, the detectors 312 may preferentially detect the thermal neutrons, and moreover, the shielding arrangement 314 may be formed from a material that preferentially absorbs thermal neutrons. As a result, the thermal neutrons that are not absorbed by a particular detector have a likelihood of being absorbed by the shielding arrangement 314 before interacting with a different detector. In this manner, the azimuthal sensitivity in the thermal gate may be utilized in order to detect wellbore characteristics. The azimuthal sensitivity is expected to be lower for the burst gate data due to significant amount of higher energy neutrons in that gate that cannot be shielded through high absorption cross section shielding material.

As will be described in detail below, the azimuthal sensitivity of the detection unit 304 of the illustrated embodiment may be improved by delaying data acquisition, or filtering data, until the thermal gate 320. For example, in various embodiments, waiting until the backscatter 310 is formed by substantially all thermal neutrons may increase the likelihood of both interaction with a particular radiation detector 312, as well as increase the likelihood that neutrons that do not interact with the detector 312 will be absorbed by the shielding arrangement 314, thereby providing an indication to the azimuthal position of wellbore characteristics.

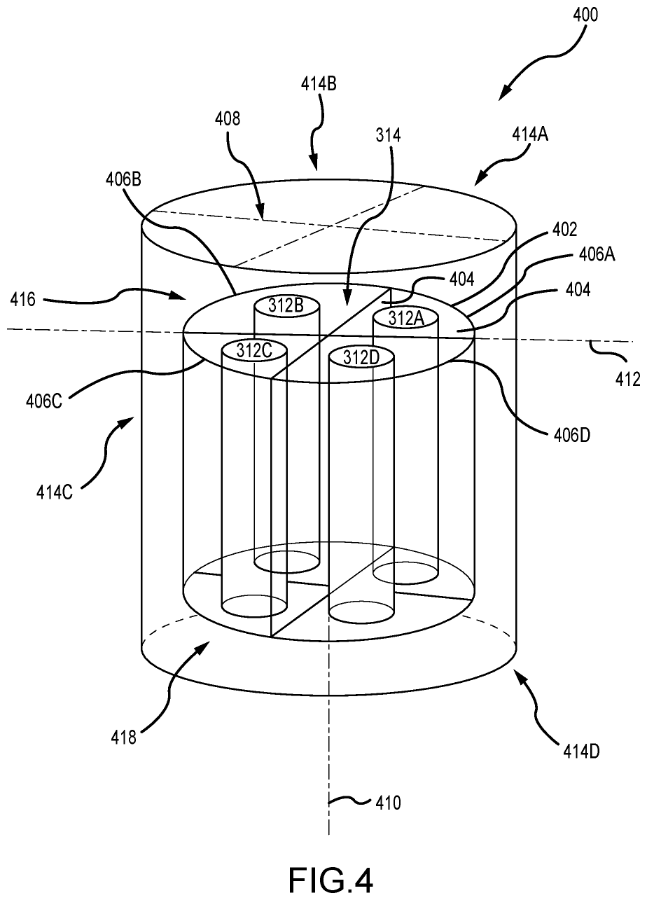

FIG. 4 is a schematic perspective view of a wellbore environment 400 including the detection unit 302 arranged within the casing 112, which is transparent in the illustrated embodiment. It should be appreciated that various components have been removed for simplicity in the following discussion. The detection unit 302 includes a housing 402, which is shown as transparent in order to illustrate the plurality of neutron detectors 312 arranged therein. It should be appreciated that the housing 402 may be formed from a variety of materials, such as metallic components that may be used to withstand wellbore pressures and temperatures. The illustrated embodiment includes four neutron detectors 312, each arranged at a respective quadrant of the detection unit 304. It should be appreciated that the relative size of the neutron detectors 312 is for illustrative purposes only and, in various embodiments, the detectors 312 may be any length and may not be substantially the same size. Furthermore, as will be described below, there may be more or fewer detectors 312 arranged within the detection unit 304.

The shielding arrangement 314 includes panels 404 arranged substantially perpendicular to one another, thereby breaking the housing 402 into detection sections 406. In the illustrated embodiment, four detection sections 406A, 406B, 406C, and 406D are illustrated dividing the housing 402 into quadrants between different circumferential ranges of the housing 402. For example, in the illustrated embodiment, the detection section 406A extends between a 0 and 90 degree range, the detection section 406B extends between a 90 and 180 degree range, the detection section 406C extends between a 180 and 270 degree range, and the detection section 406D extends between a 270 and 360 degree range. It should be appreciated that while the illustrated embodiment includes four quadrants, in various embodiments the shielding arrangement 314 may be modified to substantially separate any number of detectors 312 into any number of corresponding sections 406. For example, there may be two, three, five, six, seven, eight, nine, ten, or any reasonable number of detectors 312 arranged without the housing 402, each separated by at least a portion of the shielding arrangement 314.

The illustrated plurality of detectors 312 may be described as a detector array 408 that is arranged substantially symmetrically relative to a detection longitudinal axis 410 and a detection lateral axis 412. However, in various embodiments, the detection sections 406, and as a result the respective detectors 312 within the sections 406, may not be substantially symmetrical. For example, the detection sections 406 may not be the same size.

In various embodiments, the detection sections 406 are formed by a pair of panels 404 that converge radially inward toward the axis 410. As such, the detection sections 406 may have a wedge shape, however, other shapes and configurations may also be utilized within the scope of the present disclosure. The illustrated detection sections 406 are arranged circumferentially about the housing 402, such that each detection section 406 covers an azimuthal region of the housing 402. These respective detection sections 406 are aligned with corresponding azimuthal regions 414 of the wellbore 108, for example the casing 112 of the illustrated embodiment. As will be described below, the shielding arrangement 314 enables a correlation between the azimuthal locations of the detection sections 406 and the azimuthal regions 414 of the wellbore.

The detection sections 406 are formed, at least in part, by the panels 404, which extend from a top 416 of the detectors 312 and/or the housing 402 to a bottom 418 of the detectors 312 and/or the housing 402. As such, the detection sections 406 may be described as substantially isolating the detectors 312 from adjacent detectors 406. For example, as will be described below, in various embodiments the panels 404 are formed from a material that has a high thermal neutron cross section, and as a result, may capture thermal neutrons not captured by the respective detector 312 associated with the detection section 406. For example, if a thermal neutron were to enter the first detection section 406A and not be captured by detector 312A within the first detection section 406A, it may continue to travel until captured by the detector 312B in the second detection section 406B, thereby providing an inaccurate reading regarding the azimuthal position of the respective target. However, high thermal neutron cross section materials, such as boron or gadolinium, may be utilized to capture the neutrons and prevent the neutrons from entering other quadrants, thereby effectively isolating the detection to the quadrant facing a particular region of the wellbore 16, which may be correlated to the azimuthal position of the source.

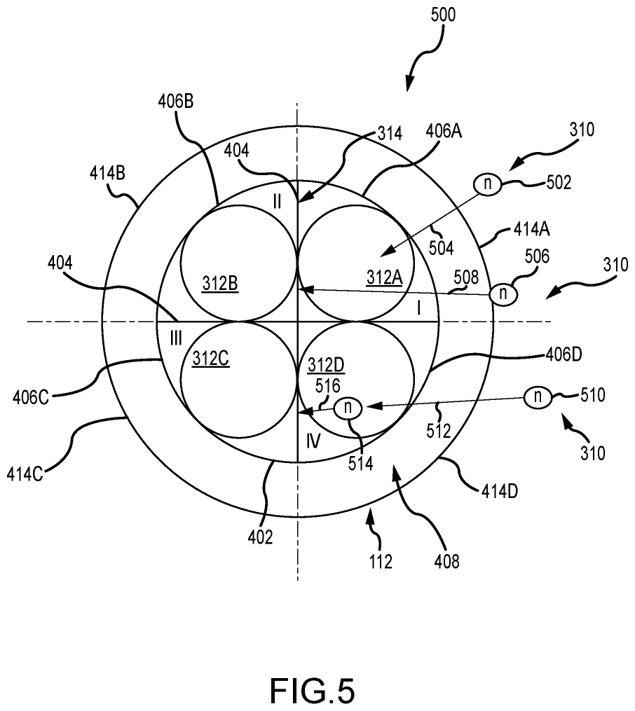

FIG. 5 is a radial cross-sectional view of a wellbore environment 500 including the detection unit 304 receiving backscatter 310. The detection unit 304 includes the detector array 408 including the plurality of detectors 312 arranged within the detection sections 406A, 406B, 406C, 406D formed by the shielding arrangement 314. As described above, the detection sections 406A, 406B, 406C, 406D corresponding to respective azimuthal regions 414A, 414B, 414C, 414D of the casing 112. In various embodiments, the detection sections 406A, 406B, 406C, 406D substantially isolate respective detectors 312 such that thermal radiation does not cross or leak into adjacent sections 406A, 406B, 406C, 406D. As described above, in various embodiments, image data may be acquired during the thermal gate 320 associated with a pulsed neutron generator, and as a result, substantially all of the neutrons may be thermal neutrons.

By way of example only, a first thermal neutron 502 may move toward the detection section 406A, as represented by the arrow 504. In various embodiments, the first thermal neutron 502 is captured within the detector 312A and a count may be determined indicative of the neutron capture. However, in various embodiments, a second thermal neutron 506 may move toward the detection section 406A, as represented by the arrow 508. If the second thermal neutron 506 is not captured by the detector 312A, it may continue to move toward the detection section 406B. Without the panel 404, the detector 312B in the detection section 406B may capture the second thermal neutron 506, thereby registering a count from a source at a substantially opposite azimuthal position. However, as illustrated in FIG. 5, the second thermal neutron 506 is captured by the panel 404, thereby blocking ingress of the second thermal neutron 506 into the detection section 406B. In other words, in various embodiments, the panels 404 forming at least a portion of the detection sections 406A, 406B, 406C, and 406D limit a radial distance into the housing that the thermal neutrons may travel before being captured or before interacting with a material having a high absorption cross section to increase the likelihood of capture.

In various embodiments, fast or epithermal neutrons may be reflected back toward the detection section 406C. For example, if image data were acquired during the burst gate 318, approximately 60 to 80 percent of the data will be from higher energy epithermal and fast neutrons. As noted above, fast or epithermal neutrons may not be efficiently absorbed by various types of neutron detectors, and as a result, may continue to interact with various particles upon reaching the housing 402. By way of example, a first epithermal neutron 510 may move toward the detection section 406D, as represented by the arrow 512. Through various interactions, the first epithermal neutron 510 may become a third thermal neutron 514 within the detection section 406D and could potentially be captured by the neutron detector 312D. However, in other embodiments, the third thermal neutron 514 may move toward the detection section 406C, as illustrated by the arrow 516. The panel 404 of the shielding arrangement 314 may capture the third neutron 514 before it leaks into the detection section 406C, thereby preventing recordation of the third thermal neutron 514 by the detector 312C. In this manner, the shielding arrangement 314 may reduce the likelihood that newly generated thermal neutrons are captured by detectors 312 in different sections that are not aligned with the source of the neutrons. As a result, an azimuthal representation of the source of the neutrons, and associated defects, may be generated via incorporation of the shielding arrangement 314. However, it should be appreciated that, in embodiments, the first epithermal neutron 510 may not thermalize until reaching the detection section 406C, and then may be detected by the detector 312C. To potentially avoid such an instance, the data acquisition may be conducted during the thermal gate 320, where the neutrons will be thermal neutrons. As described above, the high absorption cross section materials coated on the shielding material 314 in the detection unit 304 will absorb thermal neutrons preferentially. Therefore, the shielding in the detection unit 304 will be relatively inefficient in stopping the high energy neutrons. Therefore, the impact of the shielding material 314 in the detection unit 304 will mainly be on the thermal neutrons. The azimuthal sensitivity increase with the tool is expected from the thermal gate data since all the neutrons are thermal in the thermal gate. The azimuthal sensitivity increase will be minimal for the burst gate data since most of the neutrons are higher energy neutrons that cannot be shielded by the shielding material 314.

Accordingly, the shielding arrangement 314 of the illustrated embodiment performs a thermal neutron reduction function. Each detector 312 detects neutrons coming from the external world while any thermal neutrons coming from the other quadrants may be blocked and/or captured by the shielding arrangement 314. As a result, the volume from which each detector 312 is being fed is going to be one quarter of the overall volume (in the embodiment with four quadrants) making the total signal smaller. Accordingly, in an example of a signal from a flaw in the cement between casings, the chances of being detectable increases because it is sitting on top of a smaller overall signal. Moreover, because each quadrant will be facing a different azimuthal segment, azimuthal sensitivity to the overall measurements is enabled.

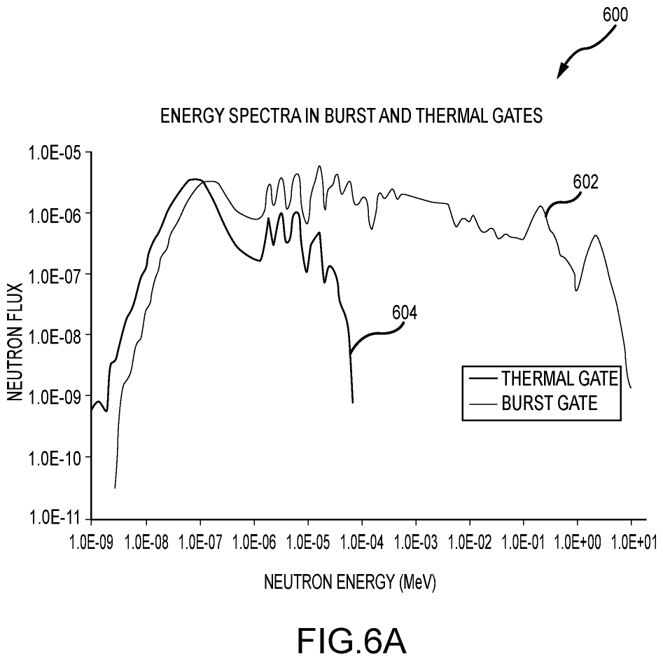

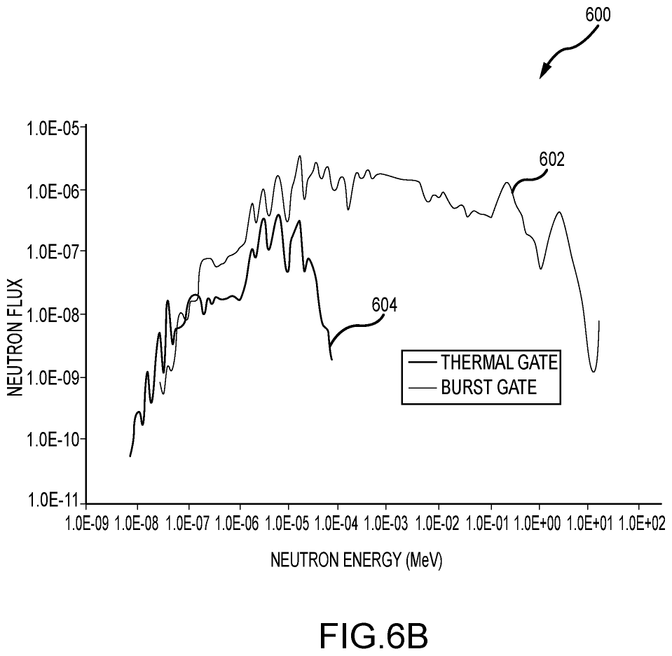

FIGS. 6A and 6B are graphical representations 600 of energy spectra in burst and thermal gates. The embodiment illustrated in FIG. 6A includes a neutron detector, such as the neutron detector 312, arranged within detection section 406 without the benefit of the shielding arrangement 314. A burst gate flux 602 is illustrated along with a thermal gate flux 604. It should be appreciated that the burst gate refers to the initial introduction of neutrons at higher energy levels (e.g., fast neutrons) while the thermal gate is a later portion after the neutrons have interacted and/or attenuated. As illustrated in FIG. 6A, the thermal gate 604 has a significantly higher flux at lower energy levels (e.g., at thermal levels) when compared to the thermal gate 604 of FIG. 6B, which includes the shielding arrangement 314. The thermal neutron spectrum is shifted to lower thermal energy ranges in FIG. 6A, while burst gate neutron spectrum has a lot of high energy neutrons available in the system. In contrast, FIG. 6B shows a drastically reduced thermal gate neutron spectrum for the same system. In various embodiments, the panels 404 of the shielding arrangement 314 may be thin, such as approximately 1 mm. However, the difference between the thermal spectra illustrated in FIGS. 6A and 6B is approximately two orders of magnitude. As a result, the count rate in the detectors with shielding will be approximately two orders of magnitude smaller, thereby providing a more accurate representation of the azimuthal direction of the neutrons.

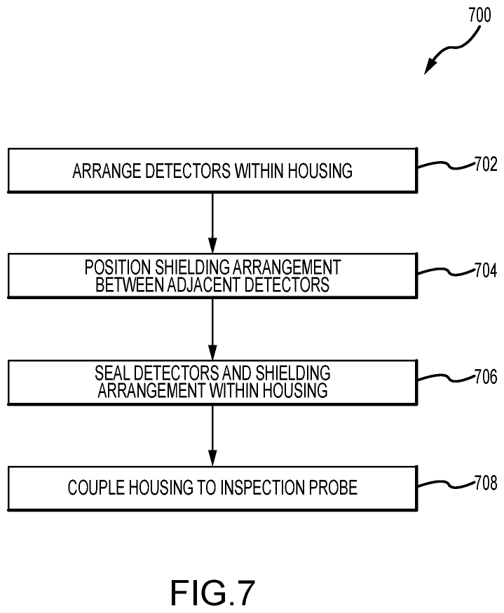

FIG. 7 is a flow chart of an embodiment of a method 700 for forming the detection unit 304 including the shielding arrangement 314 for isolating detectors 312 to enable azimuthal detection of neutrons. It should be appreciated for this method and all methods described herein that the steps may be performed in any order, or in parallel, unless otherwise explicitly stated. Moreover, there may be more or fewer steps and certain steps may be omitted, in certain embodiments. In this example, the detectors 312 are arranged within the housing 402 (block 702). For example, the detectors 312 may be symmetrically arranged, such as in the embodiment illustrated in FIG. 5, or they may be arranged in any other reasonable configuration, for example, by placing more detectors 312 at a particular location where defects may be anticipated. The shielding arrangement 314, or at least a portion thereof, may be positioned between adjacent detectors 312 (block 704). For example, in the embodiment illustrated in FIG. 5, the panels 404 of the shielding arrangement 314 are arranged to substantially isolate the respective detection sections 406 from one another. In other words, the panels 404 are arranged to block neutron flow between detection sections 406. The detectors 312 may be sealed within the housing 402 (block 706). Sealing the detectors 312 within the housing 402 may protect components from the pressures and temperatures of the downhole environment. Next, the housing 404 may be coupled to the inspection probe 104 (block 708), for example to the generation unit 302. In this manner, the inspection probe 104 may be formed to both generate and detect neutrons within the wellbore.

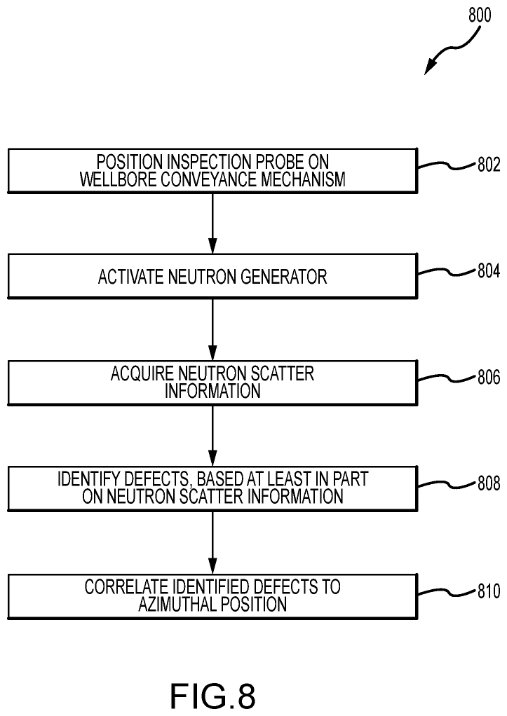

FIG. 8 is a flow chart of an embodiment of a method 800 for determining an azimuthal location of a wellbore characteristic. In this example, the inspection probe 104 is coupled to a wellbore conveyance mechanism (block 802), such as a wireline, tool string, coiled tubing, or the like. The inspection probe 104 is conveyed to a depth within the wellbore 108 and the neutron generation unit 302 is activated (block 804). The neutron generation unit 302 may be a pulsed neutron generator that emits fast neutrons that are attenuated to the thermal range, which may be detected by one or more neutron detectors 312 (block 806). For example, the neutron detectors 312 may detect backscatter neutrons from the casing 112, cement 114, formation 110, or the like. Defects within the wellbore 108 may be detected, based at least in part on the detected neutron information (block 808). It should be appreciated that detection may involve analysis of the information acquired by the detectors 312 using one or more processors having memory that may store instructions for processing the information. The information processing may be performed on the tool, or may be stored in memory or transmitted uphole for later processing. Thereafter, the azimuthal position of the defects may be correlated to the detector 312 information (block 810). For example, the azimuthal location of the detection sections 406A, 406B, 406C, 406D may be correlated to the azimuthal regions 414A, 414B, 414C, 414D. Thereafter, a determined wellbore characteristic may be recognized in one detector but not another. As a result, the azimuthal position of the defect may be correlated to the particular detector that recognized the signal. This detection may have improved accuracy due to the shielding arrangement 314 blocking thermal neutrons from crossing into different sections 406A, 406B, 406C, 406D and generating counts that may not be aligned with the various detectors 312.

In various embodiments, one or more physical operations may be performed as a result of the information obtained from the determination of the azimuthal location of the wellbore characteristic. These physical operations may be directionally dependent or independent, and may further be specialized based on the calculated property, for example, the azimuthal location of the wellbore characteristic. Non-limiting examples include performing remediation operations for defects within the wellbore, deploying sensors for monitoring ongoing operations within the wellbore, targeting wellbore interventions (e.g., completion tasks, perforating tasks, formation stimulation, etc.), and the like.

In various embodiments, various instrumentation units and data collection units may be utilized that may include a digital and/or an analog system. For example, the inspection probe 104 may include digital and/or analog systems. Furthermore, various surface and wellbore components not illustrated for clarity may also use a variety of digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the systems and methods disclosed herein. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery, magnet, electromagnet, sensor, electrode, transmitter, receiver, transceiver, antenna, controller, optical unit, electrical unit or electromechanical unit) may be included in support of the various aspects discussed herein or in support of other functions beyond this disclosure.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A downhole inspection system, comprising:
a downhole tool string lowerable into a wellbore;
a neutron imaging device forming at least a portion of the downhole tool string, the neutron imaging device operable to generate neutron imaging data for detecting a wellbore characteristic, wherein the neutron imaging device comprises:
a neutron generator operable to emit neutrons toward a target;
a plurality of neutron detectors fixed relative to the neutron generator, each neutron detector of the plurality of neutron detectors arranged equidistant from the neutron generator, and operable to detect backscattered neutrons from the target; and
a shielding arrangement to absorb thermal neutrons positioned between adjacent neutron detectors of the plurality of neutron detectors, the shielding arrangement positioned to establish azimuthal sensitivity for the respective detectors.

2. The downhole inspection system of claim 1, wherein the plurality of neutron detectors are arranged symmetrically relative to a longitudinal axis of the neutron imaging device and symmetrically relative to a lateral axis of the neutron imaging device.

3. The downhole inspection system of claim 1, wherein the shielding arrangement comprises panels extending from a top of the plurality of neutron detectors to a bottom of the plurality of neutron detectors.

4. The downhole inspection system of claim 1, wherein the shielding arrangement comprises panels isolating respective neutron detectors of the plurality of neutron detectors, wherein the panels form detection sections extending circumferentially about the neutron imaging device.

5. The downhole inspection system of claim 4, wherein the detection sections align azimuthally with sections of the wellbore such that detection of neutrons by a neutron detector of the plurality of neutron detections within a respective detection unit corresponds to an azimuthal indication of the target.

6. The downhole inspection system of claim 4, wherein the detection sections are formed from at least two panels and the neutron generation unit is a pulsed neutron generator.

7. The downhole inspection system of claim 1, wherein the shielding arrangement is formed from a high absorption cross section material.

8. The downhole inspection system of claim 1, wherein the wellbore characteristic comprises at least one of a casing defect, a cement defect, an annulus defect, or an eccentricity defect.

9. The downhole inspection system of claim 1, wherein the plurality of neutron detectors comprise at least one of a helium 3 gas detector, a lithium 6 glass detector, or a boron trifluoride detector.

10. A downhole inspection system, comprising:
a neutron generation unit operable to emit neutrons toward a target in a wellbore;
a neutron detection unit fixed relative to the neutron generator, the neutron detection unit comprising a plurality of neutron detectors, each neutron detector of the plurality of neutron detectors arranged equidistant from the neutron generator, and operable to detect neutrons from the target; and
a shielding arrangement forming at least a portion of the neutron detection unit, the shielding arrangement blocking at least a portion of the thermal neutrons, from penetrating beyond a predetermined radial location within the neutron detection unit.

11. The downhole inspection system of claim 10, wherein the plurality of neutron detectors are separated by at least a portion of the shielding arrangement.

12. The downhole inspection system of claim 10, wherein the shielding arrangement forms a plurality of detection sections, each detection section being isolated from an adjacent section by a panel of the shielding arrangement, wherein a respective neutron detector is arranged within each detection section.

13. The downhole inspection system of claim 12, wherein the plurality of detection sections are arranged circumferentially about neutron detection unit and extend radially inward an axis of the neutron detection unit, the sections converging toward the axis.

14. The downhole inspection system of claim 12, wherein each detection section is associated with an azimuthal position of the wellbore, and detection of neutrons within each detection section correlates to the target being arranged in the respective azimuthal position.

15. The downhole inspection system of claim 10, wherein the neutron detection unit forms neutron imaging data to detect a wellbore characteristic including at least one of a casing defect, a cement defect, an annulus defect, or an eccentricity defect.

16. The downhole inspection system of claim 10, wherein the shielding arrangement is formed from a high absorption cross section material and the neutron generation unit is a pulsed neutron generator.

17. A method of inspecting a wellbore, comprising:
positioning a neutron imaging device in a wellbore having a casing;
emitting neutrons toward a portion of the wellbore;
detecting thermal neutrons from the portion of the wellbore via a plurality of neutron detectors, wherein each neutron detector of the plurality of neutron detectors is positioned equidistant from a neutron generator;
generating neutron imaging data for the portion of the wellbore based at least in part on the detected thermal neutrons; and
correlating the neutron imaging data to an azimuthal position of the wellbore.

18. The method of claim 17, further comprising:
lowering a downhole tool string into the wellbore, wherein the neutron imaging device forms at least a portion of the downhole tool string.

19. The method of claim 17, further comprising:
positioning a shielding arrangement within the neutron detection unit, the shielding arrangement isolating a neutron detector of the plurality of neutron detectors from an adjacent neutron detector of the plurality of neutron detectors.

20. The method of claim 17, further comprising:
determining a wellbore characteristic of the wellbore, the wellbore characteristic including at least one of a casing defect, a cement defect, an annulus defect, or an eccentricity defect; and
determining azimuthal position of the wellbore characteristic, based at least in part on an amount of backscattered radiation detected by the neutron imaging device.

21. The method of claim 17, further comprising:
determining azimuthal wellbore characteristics by comparing low azimuthal sensitivity burst gate data to high azimuthal sensitivity thermal gate data.

22. The method of claim 17, further comprising:
determining tool and tubing eccentricity by comparing data from a plurality of neutron detectors.
